(19) United States
(12) Patent Application Publication
(10) Pub. No.: US 2005/0228714 A1
(43) Pub. Date: Oct. 13, 2005

(54) Method for presenting opinions and measuring social (intangible) audits

(76) Inventor: Richard Spady, Bellevue, WA (US)

Correspondence Address: THOMAS W. SECREST, 151 N. MARKET BLVD., P.O. BOX 1303, CHEHALIS, WA, 98532, US

(21) Appl. No.: 10/821,569

(22) Filed: Apr. 9, 2004

(51) Int. Cl. G06F 17/60

(52) U.S. Cl. 705/12

(57) ABSTRACT

This invention is directed to the presentment of information. The information can be secured from a small number of participants such as three, four, or five participants or can be secured from a large number of participants such as 1,000 participants or more. The participant answers a question. Then, the answers are tabulated. A polarization value can be determined showing the degree of polarization of the participants with respect to that question. The polarization value may be the ratio of the number of participants to have reached a decision in regard to the question versus the total number of participants taking the questions. Also, a consensus value can be determined from this information in that the consensus value is a ratio of the number of participants answering yes to the total number of participants answering yes and no. The value of this invention is that a large amount of information can be disclosed in a small range of percentages so that a person reviewing the information can reach a decision without having to review a large amount of information. In essence, with this invention the information is condensed so that a person reviewing the information can reasonably retain a lot of the information in a person's mind.

### CROSS-REFERENCES TO RELATED PATENT APPLICATIONS (IF ANY)

There is a related application Ser. No. 10/080,206, filing date of 2002 Feb. 22. There is a reference, viz., The Leadership Of Civilization Building, (Administrative and Civilization Theory, Symbolic Dialogue, and Citizen Skills for the 21st Century) the authors are Richard J. Spady and Richard S. Kirby, with collaboration of Cecil H. Bell, Jr. 2002, see end note 112, page 290 ISBN 0-9700534-9-5. The publisher is Forum Foundation, 4426 Second Avenue NE, Seattle, Wash. 98105-6191, (206)634-0420. Copies are in the Seattle and King County libraries, and the University of Washington Library.

A party may use the teaching and the intent of this patent without infringing the patent with the provision that the party clearly and legibly states that
PC RATING™
(POLARIZATION-CONSENSUS RATING)
CPC RATING™
(CONVERTED POLARIZATION-CONSENSUS RATING)
   are trademarks and with patent pending of the Forum Foundation, a non-profit corporation of the state of Washington, having address at 4426 Second Avenue NE, Seattle, Wash. 98105-6191; web-site, www.ForumFoundation.org/, and are used by permission of the Forum Foundation. A main objective of this patent is to disclose a social algorithmic process for expressing a large amount of meaningful information in two percentage figures.

### STATEMENT AS TO RIGHTS TO INVENTIONS MADE UNDER FEDERALLY SPONSORED RESEARCH AND DEVELOPMENT (IF ANY)

This invention was developed with private funds and there was no federally assisted funds.

### REFERENCE TO A “MICROFICHE APPENDIX”

This section is not applicable to this subject matter.

### BACKGROUND OF THE INVENTION

1. Field of the Invention

An outline of the invention is presented in the following paragraphs.

A statement or question is presented to a number of people.

A person, as an individual, selects an answer to the statement or question.

The answers of many people are totaled to represent the collective opinions of the people.

The answers are totaled and arranged as a short concise presentation of the collective opinions of the people.

One special feature of our Fast Forum® computer program includes the use of a social indicator invented in 1969 called the Polarization-Consensus Rating (PC Rating™).

A problem arose because the first use of the technique in a community setting in 1969 involved only raw score responses to yes/no questions. With several hundred people participating, what did it really mean if large numbers of people responded yes or no or abstain? The numbers were so vast that one's mind could not easily comprehend their meaning and could not confidently form judgments.

I did not want to use conventional statistical symbols as standard deviation or variance because these conventional statistical symbols would frustrate the public's understanding. The purpose of participation theory is to be able to communicate meaningful information back and forth between and among leaders and the people easily and without “information overload”.

I reasoned that the most widely understood statistical symbol among nontechnical people was the percentage sign (%). So, after about a month of struggle, the POLARIZATION-CONSENSUS RATING (PC Rating™ was created. It consisted simply of two percentages in juxtaposition. For every yes/no question, the Fast Forum software calculates a PC Rating™ which uses ordinary percentages to illustrate the degree to which a group was polarized and in agreement in the group.

The first percentage, the Polarization Rating, is a measure of those who were “polarized” (i.e., who answered either yes or no—excluding those who abstained or objected), divided by the total number of participants, multiplied by 100.

Numerator=sum of number of yes and no answers.

Denominator=number of participants.
POLARIZATION RATING in percentage={(Sum of number yes and no answers)/(Number of participants)}×(100)

Generally a 70% or more polarization response (better than 2 out of 3) rating is considered to be “good data”. The data is somewhat questionable as it falls below 70% polarization although it may still provide useful information.

The second percentage, the Consensus Rating, is a measure of the opinion of people showing who answered “yes”, divided by the total number of participants who were polarized and answered yes or no and excluding those who abstained or objected, multiplied by 100.

Numerator=number of yes answers.

Denominator=sum of number of yes and no answers.
Consensus Rating in percentage={(Number of yes answers)/(Sum of number of yes and no answers)}×(100)

A legend often used on printed profile reports is:
PC RATING™
“POLARIZATION RATING” (75%-80) “CONSENSUS RATING”

Polarization Rating:

A measure of the weight given an idea or question by the people participating. The polarization rating is the percentage of people participating who answered yes or no (excluding those who abstained or objected). Thus: A polarization rating of 100% means everyone participating answered yes or no. A rating of 50% means half answered yes or no. A rating of 0% means no one answered yes or no (thus, everyone abstained or objected). In the foregoing example there is a polarization rating of 75% and a consensus rating of 80, viz., the percentage of yes answers from a total of yes and no answers.

Consensus Rating:

A measure of the opinion given by those people answering yes or no. The consensus rating is the percentage of people answering yes of those who answered yes or no, i.e., the % positive response (excluding those who abstained or objected). Thus: A consensus rating above 50 means the people answering favored the idea—up to 100 which means unanimously favorable. A rating below 50 means they were more against the idea than there were for the idea, down to zero which means they were unanimously against it.

When juxtaposed, these two percentages have an advantage over conventional social indicators. The participants can see at a glance how close or far apart they are on key issues. For example, a Consensus Rating of 50 means people polarized were split 50-50. Seventy-five means three out of four answered yes, and thus one out of four answered no. One hundred means everyone polarized answered yes, and no one answered no. And zero means no one answered yes thus everyone polarized answered no.

A Polarization-Consensus Rating expressed, for example, as: (80%-66) means 80% of the people participating were polarized answering yes or no. Thus, 20% abstained or objected. And of those participants who were polarized, two out of three answered yes and thus one out of three answered no. The expression is read aloud as “80% had 66 consensus”. With a little practice, the PC Rating™ becomes a very efficient social indicator as most people understand percentages and large and small groups can be compared easily without “information overload” to leaders and to others who reference the data.

The results reported will not show anyone what is “right or wrong”. The results, however, will show what participants believe and perceive is right or wrong at that point in time, i.e., the Zeitgeist (“The spirit of the time”—Webster). Mathematically, the results are 100% accurate (barring unintentional errors). There is no percentage of error as in statistical random sampling because the Fast Forum technique uses only “statistical universes” and everyone is enabled who wishes to participate e.g., the entire classroom, the entire school, the entire school district or all schools in the state, or nation.

In Summary:

Understanding the Polarization Rating,
Consensus Rating, & PC Rating ™
POLLED POPULATION = 100

| | | |
|---|---|---|
| Yes | No | Abstain + Object |

| | A | B | C | D |
|---|---|---|---|---|
| Results: | 75 | 15 | 10 | 0 |

$\begin{matrix}Polarization Rating = \frac{[ \text{A} + B ]}{[ A + B + C + D ]} \times 100 \\ = \frac{[ 75 + 15 ]}{[ 75 + 15 + 10 ]} \times 100 = 90 \%\end{matrix}$
$\begin{matrix}Consensus Rating = \frac{[ \text{A} ]}{[ A + B ]} \times 100 \\ = \frac{[ 75 ]}{[ 75 + 15 ]} \times 100 = \begin{matrix}83 \% “ yes ” \\ ( also 17 \% “ no ” )\end{matrix}\end{matrix}$
Polarization-Consensus Rating (PC Rating) = (90% − 83)

read as “90% had 83 consensus”

For clarification here, the answers are presented in two forms.

The first form, see Table 1, following, showing the actual numbers of yes, no, abstain, and object answers and the results are presented in percentage form in the PC Rating™.

For example, assume 1000 participants were tabulated:

TABLE 1
RESULTS IN NUMBERS

| TOTAL | YES | NO | ABSTAIN | OBJECT | PC RATING ™ | READ AS |
|---|---|---|---|---|---|---|
| 1000 | 1000 | 0 | 0 | 0 | (100%-100) | “100% had 100 consensus.” |
| 1000 | 750 | 250 | 0 | 0 | (100%-75) | “100% had 75 consensus.” |
| 1000 | 500 | 500 | 0 | 0 | (100%-50) | “100% had 50 consensus.” |
| 1000 | 250 | 750 | 0 | 0 | (100%-25) | “100% had 25 consensus.” |
| 1000 | 0 | 1000 | 0 | 0 | (100%-0) | “100% had zero consensus.” |
| 1000 | 0 | 0 | 1000 | 0 | (0%-0) | “Zero % had zero consensus.” |
| 1000 | 600 | 200 | 100 | 100 | (80%-75) | “80% had 75 consensus.” |
| 1000 | 600 | 200 | 200 | 0 | (80%-75) | “80% had 75 consensus.” |
| 1000 | 600 | 200 | 0 | 200 | (80%-75) | “80% had 75 consensus.” |
| 1000 | 250 | 250 | 400 | 100 | (50%-50) | “50% had 50 consensus.” |

The second form, see Table 2, following, is that the answers are presented in percentages for yes, no, abstain, and object answers and the results are presented in percentage form in the PC Rating™.

In Table 2 there is presented the results of 781 participants. 94% answered yes or no and were polarized. Table 2 simultaneously conveys that 6% abstained or objected to the question. Since the consensus rating of 89 shown above is the percent positive response of those polarized in answering yes or no, it simultaneously conveys that 11% of those polarized answered no.

TABLE 2
781 PARTICIPANTS

| YES | NO | ABSTAIN | OBJECT | PC RATING ™ | READ AS |
|---|---|---|---|---|---|
| 84% | 10% | 4% | 2% | 94%-89* | “94% had 89 |
| | | | | | consensus” |

(*NOTE: These numbers could be off plus or minus two due to the effects of rounding by the computer.)

Therefore, a consensus rating above 50 means the people answering were favorable. A consensus rating of 100 means unanimously favorable. A consensus rating below 50 means the participants were unfavorable to the idea. A consensus rating of zero means unanimously unfavorable. A consensus rating of 50, means those polarized and answering yes or no were split “fifty-fifty” with half saying yes and half saying no. Since the Forum Foundation computer program can rerank the questions by polarization rating, if desired from their original order, additional insights are gained in analysis. One then learns also the kinds of questions people feel able to answer (which rise toward the top of the list) as against those questions where people abstain or object (they may need more information or the wording is not clear which then drops the questions toward the bottom of the list). If a polarization rating falls below 70%, from my experience, I take the consensus rating measuring the opinion as not conclusive because significant numbers of people feel unable to answer yes or no. However, the consensus rating can still provide much insight. Experience shows that the polarization rating of most responsible questions is often generally over 70.

The polarization rating is of value in the analysis of questions posed. A low polarization rating may indicate a poorly worded question. A high polarization rating may indicate a well worded question. From the polarization rating the question may be more clearly judged to be appropriate.

TABLE 1 demonstrates the principle behind the calculation of the Polarization-Consensus Rating. The actual data shown on a computer profile report shows the percentage of yes and no responses and the actual numbers of the participants for each category requested, e.g., gender, age, etc.

Another example for explanation is TABLE 3 where the participants are shown in numbers.

TABLE 3

| | | | AB- | OB- | PC | |
|---|---|---|---|---|---|---|
| TOTAL | YES | NO | STAIN | JECT | RATING | MEANING |
| 1000 | 600 | 200 | 100 | 100 | (80%-75) | “80% HAD 75 |
| | | | | | | CONSENSUS.” |

In TABLE 4 the participants are in percents as normally shown instead of numbers.

TABLE 4

| | | | AB- | | PC | |
|---|---|---|---|---|---|---|
| TOTAL | YES | NO | STAIN | OBJECT | RATING | CATEGORY |
| 1000 | 60% | 20% | 10% | 10% | (80%-75) | Youth |

TABLE 3 and TABLE 4 express the same meaning in different forms.

Another example is two actual profile reports from middle school students with results by classes and again by gender that showed the following values for the question,

TABLE 5
Have you ever been pressured into taking drugs?

| | | | AB- | | PC | CATEGORY |
|---|---|---|---|---|---|---|
| TOTAL | YES | NO | STAIN | OBJECT | RATING | (CLASS) |
| 65 | 6% | 91% | 3% | 0% | (97%-6) | 6TH GRADE |
| 98 | 10% | 85% | 5% | 0% | (95%-11) | 7TH GRADE |
| 84 | 18% | 81% | 1% | 0% | (99%-18) | 8TH GRADE |
| 71 | 18% | 79% | 3% | 0% | (97%-19) | NOT IDENT. |
| 318 | 13% | 84% | 3% | 0% | (97%-14) | Total |

2. Description of the Related Art Including Information Disclosed Under 37 CFR 1.97 and 37 CFR 1.98

There is no known related prior art. A patent search was not made.

A second special feature of our Fast Forum computer program includes use of a social indicator we have named Converted Polarization-Consensus Rating CPC Rating™.

### BRIEF SUMMARY OF THE INVENTION

There is a Rensis Likert value scale soliciting five answers. For example, the value scale has: (1) strongly agree, (2) agree, (3) neutral, (4) disagree, (5) strongly disagree, plus we have added to every question (6) abstain, and (7) object.

The Likert value scale is more complicated than the yes, no, abstain, and object answer scale.

This invention is to take the answers in the Likert value scale of seven answers and convert them to a short concise presentation of the main part of the question.

A purpose of this invention is to formulate answers in the Likert value scale of strongly agree, agree, neutral, disagree, strongly disagree, plus abstain, and object in a more easily understood and comprehended format.

Additional objects, advantages and novel features of the invention will be set forth in part in the description which follows, and in part will become apparent to those skilled in the art upon examination of the following or may be learned by the practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWING(S)

There is no drawing.

### DETAILED DESCRIPTION OF THE INVENTION

When the PC Rating™ was originally designed and published in 1969, the need was to better understand the responses of several hundred participants. It was difficult for one's mind to comprehend the meaning of the yes/no/abstain raw data. After struggling for a month with the problem, I devised the PC Rating™, Polarization-Consensus Rating™. It worked. However, a new problem arose recently in preparing to administer regularly the “State of the Union Address and the Youth of America” project.

I felt it was not appropriate in my research to ask young people, their parents, and others to respond by yes/no/abstain to all questions derived from the State of the Union Address. Young people needed more latitude to respond as they search in “Psycho-Social Moratorium” (Erik Erikson) that is, a “timeout place to talk” for meaning. So, I used Likert value scales of: Strongly Agree, Agree, Neutral, Disagree, Strongly Disagree, plus Abstain, and Object which we invented. {Rensis Likert, The Human Organization, 1967}

The Likert scale introduced a new problem. Instead of the highly efficient PC Rating™ being used, I would now report percentages for each value chosen plus abstain and objection, viz., seven percentages. While this is academic and accurate, it is also inefficient and cumbersome for young people and the public at large. A simpler and quicker way was needed to convey the opinions of people and the meaning of the opinions. There was developed the CPC Rating™ (Converted Polarization-Consensus Rating) which solves this inefficient and cumbersome problem.

Like the alphabet, it's both simple and profound. For ease of presentation and interpretation of the answers a modified Likert scale will be used. Likert scale's Strongly Agree and Agree are converted into “yes” responses. Disagree and Strongly Disagree are converted into “no” responses. Neutral responses will be converted to Abstain; then Abstain and Objection will be tabulated as usual. Thus, the Likert scale is modified to have two values instead of five values as neutral is grouped with Abstain plus Object. Results and legends in all computer reports may be shown (1) as usual showing percentages of response for each choice or (2) not shown and with the entire meaning being conveyed as a protocol, by a “Converted Polarization-Consensus Rating” (CPC Rating™ on each line.

The polarization factor will include Strongly Agree, Agree, Disagree, and Strongly Disagree.

In Summary:

Polled Population = 100

| | | | |
|---|---|---|---|
| Yes | A | strongly agree | −50 |
| | B | agree | −25 |
| Neutral | C | undecided | −5 |
| No | D | disagree | −10 |
| | E | strongly disagree | −5 |
| Object | F | | −5 |

$\begin{matrix}Converted Polarization Rating = \frac{[ \text{A} + B + D + E ]}{[ A + B + C + D ]} \times 100 = 90 \% \\ \frac{[ 50 + 25 + 10 + 5 ]}{[ 50 + 25 + 5 + 10 + 5 + 5 ]} \times 100 = 90 \%\end{matrix}$
$\begin{matrix}Consensus Rating = \frac{[ \text{A} + B ]}{[ A + B + D + E ]} \times 100 = 83 \% \\ = \frac{[ 50 + 25 ]}{[ 50 + 25 + 10 + 5 ]} \times 100 = 83 \% \end{matrix}$
i.e. = 83% “yes”
thus = 17% no
Converted Polarization − Consensus Rating (CPC Rating ™) =
(90% − 83)
read as “90% had 83 consensus”

Computer software can reorder all questions by Polarization Rating (whether yes/no questions or not) simply by calculating the abstains and objections which proportionately depress or enlarge the rating. For example, if all questions receive a Polarization Rating above 70%, i.e., it is indicating “good” data, it means there is only one number, the Consensus Rating, to convey the meaning of responses instead of six numbers to convey the meaning of responses. This is a big jump, in fact a quantum jump, in efficiency as a social indicator, and a real breakthrough in social science where there are not as many discoveries as in the physical sciences. With practice a person can more quickly analyze complex data with this procedure. Reports by the full Likert value scale can still be shown for academic purposes if desired. But it is doubtful, as a practical matter, that the five Likert value scales will be the paramount analysis once people understand that the Converted Consensus Rating is merely “one number that is the percentage positive of those polarized.”

An illustration of the Converted Polarization-Consensus Rating in two forms is presented in TABLE 6.

The number of people answering the questions was 100.

The Polarization Rating was determined by summing the strongly agree, agree, disagree, and strongly disagree and dividing by the number of participants (100) and multiplying by 100 to get the percentage polarized, see TABLE 6.

A Consensus Rating is determined by dividing the sum of strongly agree and agree by the sum of the strongly agree, agree, disagree, and strongly disagree and multiplying by 100.

In TABLE 6 the totals of strongly agree, agree, disagree; and strongly disagree are added to form the Polarization Rating.

TABLE 6

| | Strongly | | | | Strongly | | | CPC |
|---|---|---|---|---|---|---|---|---|
| Total | Agree | Agree | Neutral | Disagree | Disagree | Abstain | Objection | Rating ™ |
| 1. 100 | 100 | 0 | 0 | 0 | 0 | 0 | 0 | (100%-100) |
| 2. 100 | 75 | 25 | 0 | 0 | 0 | 0 | 0 | (100%-100) |
| 3. 100 | 50 | 25 | 25 | 0 | 0 | 0 | 0 | (75%-100) |
| 4. 100 | 50 | 10 | 20 | 10 | 10 | 0 | 0 | (80%-75) |
| 5. 100 | 45 | 10 | 10 | 20 | 15 | 0 | 0 | (90%-61) |
| 6. 100 | 40 | 10 | 10 | 15 | 10 | 10 | 15 | (75%-67) |
| 7. 100 | 30 | 10 | 5 | 10 | 15 | 10 | 20 | (65%-62) |
| 8. 100 | 10 | 20 | 10 | 20 | 15 | 15 | 10 | (65%-46) |

From the foregoing it is seen that I have provided a method for a person to quickly comprehend and assimilate the answers to questions regardless of the size of the groups participating. A small number of people can answer the questions or a large number of people can answer the questions or people over a large geographical area and a large segment of the population can answer the questions. Then, the answers are converted into a Converted Polarization-Consensus Rating showing the degree of polarization of people answering the questions and also the consensus of the people answering the questions.

The Converted Polarization-Consensus Rating gives the opinions of the people in a readily understandable form.

Most leaders and constituents do not have the time to do an in depth analysis of answers to probative questions. Further, a large amount of information is difficult for a leader and constituents to readily assimilate. If the leader had more available time, the leader could assimilate this relatively large amount of information. However, most leaders and constituents do not have the time to devote to analyzing complex information and assimilating the information.

The opinions of the people answering the questions should be presented in a form that the leader can make an analysis in a relatively short period of time. From the answers to the questions and a Converted Polarization-Consensus Rating, the leader can learn the feelings and the thinking of the people being questioned. This assists the leader in the making of an analysis.

From the opinions and the results and the Converted Polarization-Consensus Rating the leader is helped to formulate a policy that pleases a majority of the followers, perhaps, and yet allows the leader to realize some of his or her objectives in acts of statesmanship when appropriate.

From the answers and the Converted Polarization-Consensus Rating a leader can better estimate the best action to pursue and for how long the action should be pursued.

From the Converted Polarization-Consensus Rating the leader upon reviewing the answers can formulate a policy more appealing to the people and appropriate for the situation.

Further, the opinions of the people in answering the questions and forming the Converted Polarization-Consensus Rating can influence the action of the leader, yet the leader is free in our democratic republic to make whatever decision is best since the data generated is advisory only. A leader is even free to decide contrary to the opinions of those participating which is an act of “statesmanship”.

Thus the opinions of the people of varying backgrounds can be compared in symbolic dialogue with the use of the Converted Polarization-Consensus Rating—for example: by gender, age, race, geographic, psychographic, or role categories, etc.

The summary of the answers is presented in a form that a layman can understand, viz., percent. The conventional statistical symbols such as standard deviation or variance do not have the meaning for the layman that the term, percent, has for the layman. I consider that the expression of the results as two percentages in juxtaposition to each other is valuable as a social algorithm indicator in that the layman can understand more quickly than analyzing seven percentages on each line and often presented over several lines in a “forest” of percentages, e.g., age categories by decades.

The Polarization-Consensus Rating, PC Rating™, and the Converted Polarization-Consensus Rating, CPC Rating™, assist in the formation of theories relating to leadership decisions and the process of administration in a society.

Examples from a statewide “Water Conference” of the use of CPC Rating™ reports: A question was posed to people and their response to the question was requested. The question was, “I have a good understanding of water issues from all sides, not just my own.”

The results are in columnar form in Table 7 wherein:

| | | |
|---|---|---|
| (1) | SA | Strongly Agree |
| (2) | A | Agree |
| (3) | N | Neutral |
| (4) | D | Disagree |
| (5) | SD | Strongly Disagree |
| (6) | | Abstain |
| (7) | | Object |

Strongly Agree and Agree are converted to YES.

Strongly Disagree and Disagree are converted to NO.

Neutral is converted to Abstain.

TABLE 7 shows general replies to the question.

TABLE 7
GENERAL REPLIES
Strongly Agree 1 2 3 4 5 Strongly Disagree

| | (1) | (2) | (3) | (4) | (5) | | | | |
|---|---|---|---|---|---|---|---|---|---|
| Total | SA | A | N | D | SD | Abstain | Object | Category | CPC Rating ™ |
| 142 | 3% | 18% | 26% | 30% | 12% | 11% | 1% | Pre-test Answer | (63%-33) |
| 135 | 7% | 33% | 28% | 18% | 6% | 8% | 0% | Post-test Answer | (64%-63) |
| 0 | 0% | 0% | 0% | 0% | 0% | 0% | 0% | Not Identified | (0%-0) |
| 277 | 5% | 25% | 27% | 24% | 9% | 9% | 1% | Total* | (63%-47) |

*NOTE:
Totals can be plus or minus one from 100 due to the effects of rounding in the computer.

TABLE 8 is directed to the ethnic characteristics of people answering the same post-test question.

TABLE 8
ETHNIC CHARACTERISTICS
Strongly Agree 1 2 3 4 5 Strongly Disagree

| | (1) | (2) | (3) | (4) | (5) | Abstain | Object | | |
|---|---|---|---|---|---|---|---|---|---|
| Total | SA | A | N | D | SD | A | O | Category | CPC Rating ™ |
| 0 | 0% | 0% | 0% | 0% | 0% | 0% | 0% | African American | (0%-0) |
| 5 | 40 | 20% | 20% | 0% | 0% | 20% | 0% | Asian/Pacific | (60%-100) |
| | | | | | | | | Islander | |
| 118 | 7% | 32% | 29% | 19% | 6% | 8% | 0% | Caucasian | (64%-61) |
| 2 | 0% | 0% | 50% | 50% | 0% | 0% | 0% | Hispanic | (50%-0) |
| 5 | 0% | 60% | 0% | 0% | 2% | 20% | 0% | Native American | (80%-75) |
| 3 | 0% | 33% | 67% | 33% | 0% | 0% | 0% | Other Ethnic | (33%-100) |
| 2 | 0% | 100% | 0% | 0% | 0% | 0% | 0% | Not Identified | (100%-100) |
| 135 | 7% | 33% | 28% | 18% | 6% | 8% | 0% | Total* | (64%-63) |

TABLE 9 is directed to the locus of the respondents answering the same post-test question.

TABLE 9
LOCUS OF RESPONDENTS
Strongly Agree 1 2 3 4 5 Strongly Disagree

| | (1) | (2) | (3) | (4) | (5) | Abstain | Object | | |
|---|---|---|---|---|---|---|---|---|---|
| Total | SA | A | N | D | SD | A | O | Category | CPC Rating ™ |
| 4 | 25% | 50% | 0% | 25% | 0% | 0% | 0% | Central WA | (100%-75) |
| 11 | 9% | 27% | 45% | 9% | 0% | 9% | 0% | Eastern WA | (45%-80) |
| 117 | 7% | 32% | 27% | 19% | 7% | 8% | 0% | Western WA | (65%-61) |
| 1 | 0% | 0% | 100% | 0% | 0% | 0% | 0% | Oregon | (0%-0) |
| 2 | 0% | 50% | 0% | 0% | 0% | 50% | 0% | Not Identified | (50%-100) |
| 135 | 7% | 33% | 28% | 18% | 6% | 8% | 0% | Total* | (64%-63) |

TABLE 10 is directed to the sex of the respondents to the same post-test question.

TABLE 10
SEX OF RESPONDENTS
Strongly Agree 1 2 3 4 5 Strongly Disagree

| | (1) | (2) | (3) | (4) | (5) | Abstain | Object | | |
|---|---|---|---|---|---|---|---|---|---|
| Total | SA | A | N | D | SD | A | O | Category | CPC Rating ™ |
| 64 | 12% | 38% | 28% | 16% | 0% | 6% | 0% | Male | (66%-76) |
| 66 | 2% | 29% | 27% | 20% | 12% | 11% | 0% | Female | (62%-49) |
| 5 | 20% | 20% | 40% | 20% | 0% | 0% | 0% | Not Identified | (60%-67) |
| 135 | 7% | 33% | 28% | 18% | 6% | 8% | 0% | Total* | (64%-63) |

TABLE 11 is directed to the age of the respondents to the same post-test question.

TABLE 11
AGE OF RESPONDENTS
Strongly Agree 1 2 3 4 5 Strongly Disagree

| | (1) | (2) | (3) | (4) | (5) | Abstain | Object | | |
|---|---|---|---|---|---|---|---|---|---|
| Total | SA | A | N | D | SD | A | O | Category | CPC Rating ™ |
| 1 | 0% | 100% | 0% | 0% | 0% | 0% | 0% | Under 18 | (100% - 100) |
| 17 | 12% | 35% | 24% | 6% | 12% | 12% | 0% | 18-35 years | (65% - 73) |
| 48 | 4% | 35% | 25% | 12% | 12% | 10% | 0% | 36-50 years | (65% - 61) |
| 46 | 11% | 26% | 33% | 26% | 0% | 4% | 0% | 51-65 years | (63% - 59) |
| 21 | 5% | 29% | 33% | 24% | 0% | 10% | 0% | 66-80 years | (57% - 58) |
| 1 | 0% | 100% | 0% | 0% | 0% | 0% | 0% | Over 80 | (100% - 100) |
| 1 | 0% | 100% | 0% | 0% | 0% | 0% | 0% | Not Identified | (100% - 100) |
| 135 | 7% | 33% | 28% | 18% | 6% | 8% | 0% | Total * | (64% - 63) |

TABLE 12 is directed to the residence of the respondents.

TABLE 12
RESIDENCE OF RESPONDENTS
Strongly Agree 1 2 3 4 5 Strongly Disagree

| | (1) | (2) | (3) | (4) | (5) | Abstain | Object | | |
|---|---|---|---|---|---|---|---|---|---|
| Total | SA | A | N | D | SD | A | O | Category | CPC Rating ™ |
| 22 | 9% | 45% | 23% | 14% | 0% | 9% | 0% | Rural | (68% - 80) |
| 76 | 8% | 28% | 30% | 21% | 7% | 7% | 0% | Urban | (63% - 56) |
| 30 | 3% | 37% | 30% | 13% | 10% | 7% | 0% | Suburban | (63% - 63) |
| 7 | 14% | 29% | 14% | 14% | 0% | 29% | 0% | Not Identified | (57% - 75) |
| 135 | 7% | 33% | 28% | 18% | 6% | 8% | 0% | Total | (64% - 63) |

TABLE 13 is directed to the backgrounds of the respondents of the same post-test question.

TABLE 13
ADDITIONAL VARIOUS ROLE BACKGROUNDS AND PREFERENCES
Strongly Agree 1 2 3 4 5 Strongly Disagree

| | (1) | (2) | (3) | (4) | (5) | Abstain | Object | | |
|---|---|---|---|---|---|---|---|---|---|
| Total | SA | A | N | D | SD | A | O | Category | CPC Rating ™ |
| 16 | 19% | 25% | 19% | 25% | 0% | 12% | 0% | Agriculture | (69% - 64) |
| 39 | 3% | 18% | 33% | 31% | 3% | 13% | 0% | Church/Religion | (43% - 38) |
| 18 | 11% | 56% | 22% | 6% | 0% | 6% | 0% | Environmental | (72% - 92) |
| | | | | | | | | Group | |
| 5 | 20% | 40% | 20% | 0% | 20% | 0% | 0% | Fisheries | (80% - 75) |
| 9 | 11% | 56% | 11% | 11% | 11% | 0% | 0% | Government | (89% - 75) |
| 4 | 0% | 25% | 25% | 5% | 25% | 25% | 0% | First Nations | (50% - 50) |
| | | | | | | | | People | |
| 12 | 0% | 17% | 67% | 8% | 0% | 8% | 0% | Utility/PUD | (25% - 67) |
| 2 | 0% | 100% | 0% | 0% | 0% | 0% | 0% | Attorney | (100% - 100) |
| 28 | 7% | 36% | 25% | 14% | 14% | 4% | 0% | Other | (71% - 60) |
| 2 | 0% | 50% | 0% | 50% | 0% | 0% | 0% | Not Identified | (100% - 50) |
| 135 | 7% | 33% | 28% | 18% | 6% | 8% | 0% | Total | (64% - 63) |

Many times the leader of an organization does not have adequate time to review data used for making a decision. When data can be more quickly analyzed by a leader, then the leader can make a more informed decision. To better enable the leaders and indeed everyone to analyze the data better is the purpose of the Polarization-Consensus Rating and the Converted Polarization Rating. The result should be a more enlightened judgment by the leader and better understanding by the media (when involved) and others participating.

Another presentation of the Polarization-Consensus Rating information and the Converted Polarization-Consensus Rating information is presented in the following.

With reference to Table 7 it is seen that there is presented an eight-by-four matrix of eight columns and four rows. There are 32 pieces of information. It is time-consuming to present this much information and for an individual reviewing this information it is difficult to assimilate all of the information. I consider that a more precise presentation can be made with fewer pieces of information. Nevertheless, the overall information can be presented in a form that makes it easier to understand and to assimilate.

Tables 14-16 are for Polarization-Consensus values. Tables 17-19 are for Converted Polarization-Consensus values. The values in tables 14-19 were selected at random for illustrative purposes.

Table 14 illustrates a five-by-four matrix with five columns and four rows. The values are in numbers and the PC Rating is in percent and polarization and the consensus rating is a whole number. As an example to a value being in numbers there are a total of 125 participants with 60 of participants stating yes; with 50 of the participants stating no; ten of the participants abstained from answering; and five of the participants objected to the question. This can be repeated for the 90 participants and the 300 participants and the total of 515 participants. The PC Rating is at the right of table 14.

TABLE 14
5 × 4 PC Matrix - Answers In Numbers

| | Total | YES | NO | ABSTAIN | OBJECT | PC Rating ™ |
|---|---|---|---|---|---|---|
| | 125 | 60 | 50 | 10 | 5 | (88% - 55) |
| | 90 | 35 | 20 | 25 | 10 | (61% - 64) |
| | 300 | 175 | 90 | 25 | 10 | (88% - 66) |
| Total | 515 | 270 | 160 | 60 | 25 | (83% - 63) |

Table 15 is a five-by-four matrix based on the values of Table 14 wherein there are five columns and four rows. The answers for yes, no, abstain, and object are in percentages such as of 125 participants 48% voted yes, 40% voted no, 8% voted abstain, and 4% voted object.

TABLE 15
5 × 4 Matrix - Answers As Percent of Total

| | Total | YES | NO | ABSTAIN | OBJECT | PC Rating ™ |
|---|---|---|---|---|---|---|
| | 125 | 48% | 40% | 8% | 4% | (88% - 55) |
| | 90 | 39% | 22% | 28% | 11% | (61% - 64) |
| | 300 | 58% | 30% | 8% | 3% | (88% - 66) |
| Total | 515 | 52% | 31% | 12% | 5% | (83% - 63) |

Table 16 is for a two-by-four matrix wherein it is seen that for 125 participants there is an 88% polarization and a 55% consensus. A person giving the presentation has a feeling of being more accurate with fewer percentage figures.

TABLE 16
CONDENSED POLARIZED-CONSENSUS DATA

| | Total | PC Rating ™ |
|---|---|---|
| | 125 | (88%-55) |
| | 90 | (61%-64) |
| | 300 | (88%-66) |
| Total | 515 | (83%-63) |

It is easier for a person referring to the subject matter of Tables 14-16 to see that in Table 20 there are eight pieces of information while in Tables 14 and 15 there are 20 pieces of information. It is easier to remember and to analyze eight pieces of information as contrasted to 20 pieces of information.

Tables, 17, 18 and 19 are directed to the Likert Scale matrix.

Table 17 is an eight-by-five Likert Scale matrix and actual values of participants. For example, the first row has a total of 380 participants with 25 strongly agreeing; 150 agreeing; 25 being neutral; 125 disagreeing; 30 strongly disagreeing; 15 abstaining; and 10 objecting. The CPC Rating (Converted Polarization-Consensus Rating) is 87% with 53% consensus. In Table 17 there are eight columns and five rows.

TABLE 17
An 8 × 5 LIKERT SCALE MATRIX IN ACTUAL VALUE

| | Total | SA | A | N | D | SD | ABSTAIN | OBJECT | CPC Rating ™ |
|---|---|---|---|---|---|---|---|---|---|
| | 380 | 25 | 150 | 25 | 125 | 30 | 15 | 10 | (87% - 53) |
| | 90 | 8 | 28 | 12 | 18 | 14 | 6 | 4 | (76% - 53) |
| | 83 | 14 | 26 | 8 | 18 | 9 | 3 | 5 | (81% - 60) |
| | 68 | 18 | 27 | 3 | 9 | 7 | 2 | 2 | (90% - 74) |
| Total | 621 | 65 | 231 | 48 | 170 | 60 | 26 | 21 | (85% - 56) |

Table 18 is eight-by-five Likert Scale matrix with the information of Table 17 in percentages instead of actual value.

TABLE 18
An 8 × 5 LIKERT SCALE MATRIX WITH ANSWERS IN PERCENTAGES

| | Total | SA | A | N | D | SD | ABSTAIN | OBJECT | CPC Rating ™ |
|---|---|---|---|---|---|---|---|---|---|
| | 380 | 7 | 40 | 7 | 33 | 8 | 4 | 3 | (87% - 53) |
| | 90 | 9 | 31 | 13 | 20 | 16 | 7 | 4 | (76% - 53) |
| | 83 | 17 | 31 | 10 | 22 | 11 | 4 | 6 | (81% - 60) |
| | 68 | 26 | 40 | 4 | 13 | 10 | 3 | 3 | (90% - 74) |
| Total | 621 | 10 | 37 | 8 | 27 | 10 | 4 | 3 | (85% - 56) |

Table 19 is a Converted Polarization-Consensus data summation and is a two-by-five matrix having two columns and five rows. For example, there are 380 participants with a CPC Rating of (87%-53).

A comparison of Tables 17 and 18 with Table 19 illustrates that the overall information in Table 19 comprises 10 figures whereby the overall information in Table 17 and the overall information in Table 18 each comprise 40 figures. For a person making an analysis it is easier to manipulate and bring forth 10 figures as compared with 40 figures. This is a significant increase in efficiency for the social indicators.

TABLE 19
CONVERTED POLARIZATION-CONSENSUS RATING

| | Total | PC Rating ™ |
|---|---|---|
| | 380 | (87%-53) |
| | 90 | (76%-53) |
| | 83 | (81%-60) |
| | 68 | (90%-74) |
| Total | 621 | (87%-60) |

Table 20 presents the five-by-ten matrix of Table 1 as a two-by-ten matrix. There is a total of answers and a Polarized Consensus Rating.

TABLE 20
POLARIZED CONSENSUS RATING

| Total | PC Rating ™ |
|---|---|
| 1000 | (100%-100) |
| 1000 | (100%-75) |
| 1000 | (100%-50) |
| 1000 | (100%-25) |
| 1000 | (100%-0) |
| 1000 | (0%-0) |
| 1000 | (80%-75) |
| 1000 | (80%-75) |
| 1000 | (80%-75) |
| 1000 | (50%-50) |

In Table 21 the five-by-one matrix of Table 3 is presented as a two-by-one matrix.

TABLE 21
POLARIZED CONSENSUS RATING

| Total | PC Rating ™ |
|---|---|
| 1000 | (80%-75) |

Table 22 is presented as a two-by-five matrix of the five-by-five matrix of Table 5.

TABLE 22
POLARIZED CONSENSUS RATING

| Total | PC Rating ™ | Category (Class) |
|---|---|---|
| 65 | (97%-6) | 6th Grade |
| 98 | (95%-11) | 7th Grade |
| 84 | (99%-18) | 8th Grade |
| 71 | (97%-19) | Not Identified |
| 31 | (97%-14) | Total |

In Table 23 the eight-by-eight matrix of Table 6 is now presented as an two-by-eight matrix on a Converted Polarization-Consensus form.

TABLE 23

| Total | CPC Rating ™ |
|---|---|
| 100 | (100%-100) |
| 100 | (100%-100) |
| 100 | (75%-100) |
| 100 | (80%-75) |
| 100 | (90%-61) |
| 100 | (75%-67) |
| 100 | (65%-62) |
| 100 | (65%-46) |

The eight-by-four matrix of Table 7 is presented as a two-by-four matrix in Table 24.

TABLE 24
CONVERTED POLARIZED CONSENSUS RATING

| Total | PC Rating ™ | |
|---|---|---|
| 142 | (63%-33) | Pre-test Answer |
| 135 | (64%-63) | Pre-test Answer |
| 0 | (0%-0) | Not Identified |
| 277 | (63%-47) | Total |

The eight-by-eight matrix of Table 8 is presented as a two-by-eight matrix of Table 25.

TABLE 25
POLARIZED CONSENSUS RATING

| Total | PC Rating ™ | Category |
|---|---|---|
| 0 | (0%-0) | African-American |
| 5 | (60%-100) | Asian Pacific Islander |
| 118 | (64%-61) | Caucasian |
| 2 | (50%-0) | Hispanic |
| 5 | (80%-75) | Native American |
| 3 | (33%-100) | Other Ethnic |
| 2 | (100%-100) | Not Identified |
| 135 | (64%-63) | Total |

The eight-by-six matrix of Table 9 is presented as a two-by-six matrix of Table 26 having a Converted Polarization Consensus Rating.

TABLE 26
CONVERTED POLARIZED CONSENSUS RATING

| Total | CPC Rating ™ | Category |
|---|---|---|
| 4 | (100%-75) | Central Washington |
| 11 | (45%-80) | Eastern Washington |
| 117 | (65%-61) | Western Washington |
| 1 | (0%-0) | Oregon |
| 2 | (50%-100) | Not Identified |
| 135 | (64%-63) | Total |

The eight-by-five matrix of Table 12 is presented as a two-by-five matrix of Table 27.

TABLE 27
CONVERTED POLARIZED CONSENSUS RATING

| Total | CPC Rating ™ | Category |
|---|---|---|
| 22 | (68% - 80) | Rural |
| 76 | (63% - 56) | Urban |
| 30 | (63% - 63) | Suburban |
| 7 | (57% - 75) | Not Identified |
| 135 | (64% - 63) | Total |

The eight-by-eleven matrix of Table 13 is presented as a two-by-eleven matrix of Table 28.

TABLE 28
CONVERTED POLARIZED CONSENSUS RATING

| Total | CPC Rating ™ | Category |
|---|---|---|
| 16 | (69% - 64) | Agriculture |
| 39 | (43% - 38) | Church/Religion |
| 18 | (72% - 92) | Environmental Group |
| 5 | (80% - 75) | Fisheries |
| 9 | (89% - 75) | Government |
| 4 | (50% - 50) | First Nations People |
| 12 | (25% - 67) | Utility/PUD |
| 2 | (100% - 100) | Attorney |
| 28 | (71% - 60) | Other |
| 2 | (100% - 50) | Not Identified |
| 135 | (64% - 63) | Total |

From the foregoing Tables 20-28 it is seen that the main part of the answers and materials was presented in a much smaller matrix which is easier to handle and to present in an analysis.

The Unified Social Field Theory concerns the functioning of society as a whole. (Ref: THE LEADERSHIP OF CIVILIZATION THEORY, page 116.) It is a theory which asserts the fundamental unity of all the constituent parts and levels of society. Thus, it expresses an important idea about society:

The theory states: “If a theory used at the micro-level the relationship among individuals is accurate for an individual or organization, then it is equally valid at the macro-level.”

For example, the social dynamics operative in simple groups and organizations can also be spoken of for institutions and nations. If these dynamics subsequently prove out at a lower level, then they should be applicable at a higher level. In other words, if it works at the micro level, it will work at the macro level. It is more difficult to test at the macro level as there is more data to manipulate.

The content of the Unified Social Field Theory is a new expression of an old idea that “life is one.” (Ref: The Leadership of Civilization Building, page 116.)

Medievals called this the Great Chain of Being, and this idea is fundamental to sociology as a whole. Indeed, the Unified Social Field Theory seems to reinforce the “Mass-Time Triangle” cosmological model of our late colleague, Dr. Stuart C. Dodd. In this remarkable study, Dr. Dodd looked at the march of civilization through a mathematical lens. At one place in his writing, I noticed a curious reference to “one to the third power.” Since the cube of one is still one, I asked him what it meant.

“What it means is unity,” Dr. Dodd said. “Unity is what we in the human race are moving toward in the world.”

This brings forth an interesting conundrum: If 1=1 and 1ⁿ power also equals one, then perhaps we who are of this world—past, present, and future—are each now and always have been and always will be simultaneously an individual and a corporate (i.e., “societal”) one! I call this the “Royal One” or the “Royal¹” because it indicates that the real sovereignty—ranging from a small group or a large nation—is in the people and not the King or the dictator or the leader, i.e. “royalty.” Perhaps this in an insight that should be considered when people think about our next theory, just being introduced here now in our book, which we call Social Quantum Mechanics (SQM), in the future study of administrative theory, social science and—theology, (Ref: THE LEADERSHIP OF CIVILIZATION BUILDING, page 118). The theory states: “Physics and social-theory have much in common; both deal with the subtle organization of multitudinous elements. In the case of matter, it exists simultaneously as individual particles and as waves. In the case of people, they exist simultaneously as 1) individuals and 2) corporate (i.e., societal) entities.”

Todd Stedl at the University of Washington writes, “In 1690 Christian Huygens theorized that light was composed of waves, while in 1704 Isaac Newton explained that light was made of tiny particles. Experiments supported each of their theories. However, neither a completely-particle theory nor a completely-wave theory could explain all of the phenomena associated with light! So scientists began to think of light as both a particle and a wave.”

“One of the greatest discoveries of the twentieth century has been quantum mechanics. It is a very complex branch of physics, which rivals relativity theory for its opposition to common sense and for its use of super-advanced mathematics” (Stephen Hawking, A BRIEF HISTORY OF TIME, page 55-56). But like all science, it offers powerful imagery and conceptual apparatus for social science.

“Quantum Mechanics deals with the behavior of “quanta” [packets] of matter at the sub-atomic level. It deals with probabilities and uncertain outcomes, but as a whole its math works, and inventions such as transistors and integrated circuits depend on it.”

“The quantum theory of the emission of atomized packets of energy explains that electrons and other particles of matter behave, not in accord with “classical physics”, but more subtly. Matter is envisioned as particles that are ‘granular’ or discontinuous. All physical matter, according to the early quantum physicists, is a collection of ‘grains’ of energy that are discontinuous and discrete” explains Daniel Liderbach, author, THE NUMINOUS UNIVERSE, (Ref: THE LEADERSHIP OF CIVILIZATION BUILDING, PAGE 119).

“But quantum physics also reveals a universe, which is cooperative! Particles can be observed to behave in a manner which suggests that they have made decisions based on decisions made by other particles.”

Matter is a sub-atomic dance of collaboration. This is true even if the sub-atomic particles are far apart. There is, as physicist David Bohm says, an “implicate order.”

Old-style (classical) physics and old-style sociology postulated atoms, or social atoms (people), which were separate individuals, but “social quantum mechanics” can be seen to require a more subtle account of the elements of society and their ways of interacting. Dr. Dodd's “cosmic sociology” and “social cosmology” was a rich interaction of cosmology and sociology. Thus, our “social quantum mechanics” is a direct descendant of his work.

The subject of physics is immense and varied, including energy, matter and its elements (particles, waves, fields, quanta etc.); the power of these physical ingredients of nature, and their applicability in the service of humanity is enormous. The subject of social theory is society and its elements (individuals, groups, fields, organizations, societies) and social power, human thinking, behavior and energy, and their constituent elements. We believe it is not too much of a stretch to see that if there is an “implicate order” in the structure of matter, there may also be one at work in human society.

Indeed, according to the theory of Social Quantum Mechanics, humankind is simultaneously both separate and orchestrated; we literally “act in concert.” I further believe that the Zeitgeist (the “Spirit-of-the-Time”) is the conductor of this temporal orchestra; the musicians are the elected and duly appointed leaders, i.e., the “Chiefs of state” of society, public and private; and those who listen, i.e., the audiences, are the public, constituents, and members. Their reaction, at all organizational levels—small and large—further shapes the Zeitgeist in a purposeful, harmonic, social melody in a “symphonic fusion and rhythmic orchestration” (author, Jaideep Singh) of Civilization building subsequently effected through the dynamics of the self-fulfilling prophecy.

The result of this societal metaphorical concert? A working democratic republic with improved organizational, community, and societal mental health!

For some, societal improvement is about improving the individual's performance in society—through improved education, more personal responsibility, a greater emphasis on individual morality and the like. By their philosophy, Lone Ranger individualism is bad. The real need is for greater cooperation and community building from within every person.

For others, the real problem for societal improvement is organizational, i.e., we need better functioning organizations and institutions, mainly governments, public and private.

The truth is—that both are needed “simultaneously.”

“I think, then, that there is the possibility of the transformation of consciousness, both individually and collectively. It's important that it happen together—it's got to be both. And therefore this whole question—of communication and the ability to dialogue, the ability to participate in communication—is crucial,” (On Dialogue, Edited by Lee Nichol c 1996 Sarah Bohm, for the original material by David Bohm; Lee Nichol for selection and editorial matter, Reprinted 1997, 1998. Published by Routledge, 29 West 35th Street, New York, N.Y. 10001.)

Many-to-Many Communication Theory (and Zeitgeist communication as described) I believe is the social-theory counterpart of quantum mechanics in physics.

Social quantum mechanics is the social theory appropriate to civilization building. As quantum mechanics led to the modern world of electronics and all its benefits, so “social quantum mechanics,” I suggest, can lead to the building of brilliantly luminous civilizations of the near and far future.

But, many ask, “How can I do it? I'm just one person. I'm not rich, powerful, or influential. It is not possible in this big, impersonal world of insurmountable problems for me to count. I give up.”

Perhaps some individuals will give up, but the human race in the world can not, should not, and I believe—will not give up on the social, technical, and economic problems of our day. There is a way to be counted simultaneously as individual “quanta” and equally as participants in organizational and group relationship-webs using Many-to-Many communications and symbolic dialogue to create a vision of the future that ought to be, i.e., “ethics.”

There is a name for the process—it is called “politics.” But in this case the politicians and bureaucrats in our republic will have helped frame the larger social problems faced in common by all. Out of this routine interaction primarily by functional “chiefs of state” with their constituents in a continuous symbolic dialogue, a vision of the Zeitgeist, the “Spirit-of-the-Time” will emerge. Since the Zeitgeist is also the “Supreme Governor”, political leaders and bureaucrats should tend naturally to develop regulations and laws consistent with the common vision; to do otherwise would entail political risk for them. If they feel the people “don't have the facts”, (which is often the case) they will try to bring new information to the people. This kind of effort is a “natural factor” in action.

Yet the elected or appointed leaders will continue to make the legal and policy decisions as they now do because we live in a republic and representative government—not a pure democracy. Leaders everywhere, political and non-political, will have ample opportunity to exercise their statesmanship when they feel it is required. It is just that they will now do it in open communication with their constituents. Better governing and “following” should result, with “authority” flowing strongly from the people in support of their political, economic, cultural and other leaders, with a reduction of social and organizational tensions, greater social and economic efficiency, and an increase in happiness So, we will then have come full circle, as happiness is one of the reasons we form all “governments,” public and private—for Life, Liberty, and the Pursuit of Happiness!

The best way for people to communicate with each other is face-to-face, eyeball-to-eyeball, which is merely the counseling relationship among human beings. Everyone participates in this process whenever he or she talks and thus counsels with another person. Far from being merely preparation for change, it is dynamic change occurring itself.

But we face a problem in logistics. No one individual has the time or the physical capability to talk with but a few of one's peers in any but the smallest group or organization. At this stage of mankind's sociological and technological development, the best answer seems to be to utilize new computer and scanning communication technology to “talk” to each other “symbolically” and on paper so that people in small groups of eight to twelve, ideally without limitation as to numbers overall, can interact with each other. This will be an intellectual and rational experience in an on-going, problem-solving, creative-thinking, future oriented, social process approach. This process will be humanizing and self-actualizing, even mega-actualizing, an activity bringing dignity and relevancy to people presently lost anonymously in the vastness of large organizational, religious, and societal hinterlands. “What is wanted is knowledge, a type of knowledge that has escaped us in two hundred years of prosperous development. How to substitute human responsibility for futile strife and hatreds.” (Ref: The Leadership of Civilization Building, page 37, quote by Elton Mayo.)

Similarly, George Soros, international financier and philanthropist, writes:

“Collective decisions cannot be based on the dictates of reason; yet we cannot do without collective decisions. We need the rule of law exactly because we cannot be sure what is right and wrong. We need institutions that recognize their own fallibility and provide a mechanism for correcting their own mistakes . . . . Why should we accept open society as an ideal? The answer should be obvious by now. We cannot live as isolated individuals. As market participants, we serve our self-interest, but it does not serve our self-interest to be nothing but market participants. We need to be concerned with the society in which we live, and when it comes to collective decisions we ought to be guided by the interests of society as a whole rather than our narrow self-interest. The aggregation of narrow self-interests through the market mechanism brings unintended adverse consequences.”

“Democracy is supposed to provide a mechanism for making collective decisions that serve the best interests of the community. It is meant to achieve the same objective for collective decision making as the market mechanism does for individual decision making . . . .”

“We need a worldwide alliance of democratic countries that cooperates in promoting the principles of open society.” (Ref: L/CB page 123).

As human beings exercise and use their greatest human capacity, their ability to think, against the foils of real organizational and societal problems by personally participating in the clarification of the Zeitgeist, they will learn. This is done through the dynamics of the Socratic Method, the Theory of Learning. At the same time in the process, persons participating become “new persons,” psychologically speaking and contributing to their own happiness, to improved morale, esprit-de-corps, individual and thus community mental health. In effect, the process is therapeutic and leads to peace. First it leads to peace of mind for the individual participating, the final sanctuary for every person. If an individual can somehow capture a little piece of mind in his or her own daily routine, the world isn't all that hostile.

As more and more people in an organization achieve peace of mind, organizational peace follows. As more and more organizations achieve peace, institutional peace will follow. And when more and more of our institutions of governments, business, education, and religion achieve peace—then will humankind finally achieve the peace of civilization itself.

Civilization building means the dynamic, historical processes of human innovation and social evolution to improve the survivability of the human race and the success of the human species through its enlightened organizations and institutions.

Author Jaideep Singh argues that an “enlightened organization” is characterized by “spiritual mission, unified intentionality, egalitarian hierarchy, situational leadership, harmonious teams, relational validation, self-determined self-actualization, entrepreneurial thrust, dynamic equilibrium, and symphonic fusion—the last attribute implying the rhythmic orchestration of all the above characteristics into the organizational way of life.” (Ref: THE LEADERSHIP OF CIVILIZATION BUILDING, End Note #72, page 288.)

In our work-a-day world we are born, we are young, we are learning, we are a homemaker, we are employed or unemployed, or we are retired. Everyone participates and goes through these phases. But that constitutes our work-a-day world, which is a world in which we each have roles to play. But everyone also has a higher role to play, as a citizen of the world, with a very important task.

That task is civilization building!

We can be unemployed in the work-a-day world, but we can never be unemployed in our role as a citizen of the world. So, each of us—every last one of the now six billion people on this planet—is never truly unemployed or retired in the real sense of the word. Because from the day we are born to the day we die, we all have a singular, ongoing, inescapable responsibility: make civilization better!

Down through history, every individual has faced six questions:
“Who am I?”
“Where did I come from?”
“What is my role in life?”
“Where do I fit in?”
“Where am I going?”
“Where do I want to go?”

We believe that as humanity emerges from the Second Millenium, these six may turn out to have been the most important questions of the 20th Century. They are all spiritual questions. And of the six, the last—Where do I want to go?—implies the reciprocal question, How can I get there?, which may turn out to be the organizational question of the Third Millenium for society itself.

So, according to our theory, it is in the task of civilization building as a citizen, that each person in the world can find his or her true identity as a social being. This work, hopefully, will continue to take place within the theory of civilization which we are working to develop in the Forum Foundation and the Stuart C. Dodd Institute for Social Innovation here in Seattle. Perhaps you can help us.

Like physical science, I belive the work of theory is never finished, but each current theory should just be better than the one it replaces.

Hopefully, the research and work of Seattle's Forum Foundation will continue to update and improve the administrative and civilization theories presented in our books as concepts evolve and clarifications are made. Thus, until proven incorrect, each of the 13 administrative and civilization theories should be useful until we get a better theory. What follows is a brief summary and paraphrase of each of them as further documented in our books and this paper: (Ref: The Search For Enlightened Leadership, Vol. 1, New Administrative Theory, (Spady and Bell, 1996). The Search For Enlightened Leadership, Vol. 2, Many-to-Many Communication (Spady and Bell, 1998); The Leadership of Civilization Building (Spady and Kirby, with collaboration of Cecil H. Bell, Jr, 2002).

Administrative Theory Paraphrased:

1. The Basic Attitude in Civilization Building—One must always treat all persons with dignity, consideration and respect. We can reject or not agree with anything said, but we must always respect another person's right to say it in order to best protect one's own freedom to speak. (Ref: L/CB page 48).
2. The Theory of Learning—The Socratic Method is one of history's proven learning techniques. It has four steps: Awareness, Frustration, Insight, and Verification. The ability to learn this way through answering questions posed is a universal human ability. In the process an individual not only learns something new, but literally becomes someone new, psychologically speaking. (Ref: L/CB, page 52).
3. The Theory of Leadership—Leadership is a universal human attribute. It is a function, and not a quality reserved for the titled head of an organization. To develop leadership properly, all decisions in an organization or institution should be made at the lowest level possible, consistent with two basic premises: First, adequate information must be available with which to make a valid decision. Second, adequate resources must be available to implement the decision reached. If neither is available, the decision should be moved incrementally one level higher in the organization or institution until both valid information and adequate resources to implement the decision are available. (Ref: L/CB, page 56).
4. The Theory of Authority—Those who govern derive their power from the consent of the governed. Authority always lies with the persons to whom it applies. Authority is just another way of talking about the willingness of people to collaborate. (Ref: L/CB, page 61.
5. The Theory of Politics—A political relationship is defined as one between or among equals, and progress in a political relationship comes only from agreement, or, failing that, from compromise through collaboration; otherwise there is stalemate. Progress in a political relationship is best reached by increasing interaction and improving either the quality or the quantity of communication, and thus understanding, between or among the participants. It is a misnomer to consider any human organization as “non-political”, and it is a political right of people to be heard and to be enabled by their governors to participate viably in their organizations, institutions, governments and societies. (Ref: L/CB, page 67).
6. The Self-Fulfilling Prophecy—The way in which we perceive a situation determines our reactions to the situation. These reactions, in turn, tend to direct subsequent events toward reinforcing the original perception, i.e., are self-fulfilling. (Ref: L/CB, page 74).
7. The Administrative Process—The Administrative Process is: a) Diagnose the problem, b) Theorize its solution, c) Decide what to do about it, d) Accomplish what was decided, and e) Review what was done. It is an ongoing process. (Ref: L/CB, page 81).
8. The Helping Professions—Leaders are a part of the helping professions, which include teachers, counselors, ministers, public officials, administrators, nurses, parents, and such other persons in personal interaction with followers. Regardless of the profession, the characteristics of good and poor helpers and leaders are the same. (Ref: L/CB, pages 86 and 88).
9. The Zeitgeist Principle—To work properly, human organizations and institutions (from married couples to civilization itself) require a functional feedback communication capability. This is best accomplished in most organizations by a democratic, open, participative, reliable, viable, anonymous, routine, and objective feedback system. Most organizations, institutions, and governments in the world today have no such system which embodies a symbolic dialogue between organizational and societal leaders (i.e., elected or duly appointed “chiefs of state”) and their constituents. (Ref: L/CB, page 90).
10. The Natural Factors—Three “natural” and favorable administrative dynamics spontaneously tend to occur when organizations or institutions have a democratic, open, participative, reliable, viable, anonymous, routine, and objective feedback communication system. These dynamics improve decision-making through better diagnosis, expand individual, organizational, and a institutional learning in a process of community education, and reduce tensions and conflict leading toward peace. (Ref: L/CB, page 101).
   Civilization Theory:
11. The Unified Social Field Theory—If a theory used at the micro-level (the relationship between an individual and someone else) is accurate and valid in an organization, then it is equally valid at the macro-level in society. Each person is simultaneously an individual and a part of a corporate, societal, “one”, i.e., a “Royal One.” (Ref: L/CB, pages 116-117).
12. Social Quantum Mechanics (SQM)—Humankind leads an existence that is simultaneously both separate and orchestrated; we literally “act in concert”. The Zeitgeist (i.e., the “Spirit-of-the-time”, “supreme governor”, and “vision” of the organization or society) is the conductor of this temporal orchestra; the musicians are the elected and duly-appointed leaders of organizations and society (i.e., functional “chiefs of state”, public and private), citizens and constituents who listen and respond are the audience, and their reaction reinforces and reshapes the Zeitgeist—the “supreme governor” and “vision”—which is then effected by organizations and society through the Self-Fulfilling Prophecy. (Ref: L/CB, pages 118-120).
13. A Theory of Civilization—It is in the task of civilization building as a citizen that each person in the world can find his or her true identity as a social being. “Civilization is fundamentally spiritual, not material.” And the spiritual destiny of humankind is unity and love for each other! (Ref: L/CB, page 124).
14. The Theory of Creation—“Symbolic Dialogue” between citizens and their functional “Chiefs of State” in all organizations, public and private through Many-To-Many Communication technology (whether in nations, states, counties, cities, schools, organizations, or churches) is similar to a spiritual “Social Pentecost.” Administrative and civilization theories as perceived by the people are the “social algorithms” and “social architecture” that create the future for the human race. (Note: This theory was first conceived in Moscow, Russia about two weeks after the 9-11 terrorist attack and is not listed in the L/CB as the manuscript has already gone to the printer. However, this theory is now printed on the Trailer Page of every Fast Forum Profile Report together with a Trailer Clause, Philosophy Clause, and Certification Clause (Ref:L/CB, pages 158-159).

The late Erik H. Erikson, a pre-eminent national and international psychologist, postulated that adolescents require a “psycho-social moratorium.”

Robert Pranger, a professor of political science at the University of Washington in Seattle, wrote a booklet in 1968 entitled, The Eclipse of Citizenship. In it he stated, “This need of the adolescent for a psycho-social moratorium, as defined by Erikson (where adolescents can talk together without fear of reprisal, i.e., moratorium—no threats) is so important, it is of equal importance to the need of a small child for maternal care.”

This is in recognition that the adolescent exists at a crucible-forming time in his or her development toward maturity, and if parents and society don't get it right then, they may never get it right in the child's lifetime. The child is told by the parent, “this is a fact;” by the teacher, “this is a fact;” by the culture, “this is a fact”. But when the child reaches adolescence, he or she becomes aware of ambiguity. There are differences of opinion, everything is not cut and dried. And what every child needs at that point in his or her life are a variety of “psycho-social moratorium” experiences, i.e., public arenas where each can talk with peers and parents and others without fear of reprisal. That is, young people require a “timeout place to talk!” This can be accomplished by the use of “symbolic dialogue” which is non-threatening to the individuals participating.

This is also an “intellectual gaming” process in our schools and communities similar in scope and importance to physical gaming in schools. Instead of exercising their bodies to get stronger as in physical gaming, young people will exercise their minds to help develop their reasoning skills. While they are in their search for meaning of the facts in life as they understand them, there are no “right” or “wrong” answers during the quest itself because there are differences of opinion. The youth are just practicing how to think against the foils of the thinking of their peers, their parents, and others.

However, in the final analysis, each child will have an opportunity to receive the final counsel from his or her parents who can say, “Look, son or daughter, even though all other children say this or all other parents say that (from the reports), I want to call your attention to this fact.” They can then convey and explain their own value judgment to their own child—which is the parental prerogative.

The following quotation is from H. G. Wells, “Reach Out Their Hands Amidst the Stars”, page 230, the epilogue of The Leadership of Civilization Building.

“‘The greatest futurist of the 20th Century, perhaps of any century, was Herbert G. Wells,’ according to Edward Cornish, President, World Future Society. For that reason, we can think of no better ending for our book than to quote key extracts from Wells' address given in 1902 to the Royal Institute of Great Britain.”

“ . . . And now, if it has been possible for men by picking out a number of suggestive and significant looking things in the present, by comparing them, criticizing them, and discussing them, with a perpetual insistence upon why? without any guiding tradition, and indeed in the teeth of established beliefs, to construct this amazing searchlight of inference in the remoter past, is it really, after all, such an extravagant and hopeless thing to suggest that, by seeking for operating causes instead of for fossils, and by criticizing them as persistently and thoroughly as the geological record has been criticized, it may be possible to throw a searchlight of inference forward instead of backward, and to attain to a knowledge of coming things as clear, as universally convincing, and infinitely more important to mankind than the clear vision of the past that geology has opened to us during the nineteenth century?

“I must confess that I believe quite firmly that an inductive knowledge of a great number of things in the future is becoming a human possibility. I believe that the time is drawing near when it will be possible to suggest a systematic exploration of the future. And you must not judge the practicability of this enterprise by the failures of the past. So far nothing has been attempted, so far no first-class mind has ever focused itself upon these issues; but suppose the laws of social and political development, for example were given as many brains, were given as much attention, criticism and discussion as we have given to the laws of chemical combination during the last 50 years, what might we not expect?

“To the popular mind of today there is something very difficult in such a suggestion, soberly made. But here, in this Institution which has watched for a whole century over the splendid adolescence of science, and where the spirit of science is surely understood, you will know that as a matter of fact prophecy has always been inseparably associated with the idea of scientific research. The popular idea of scientific investigation is a vehement, aimless collection of little facts, collected as the bowerbird collects shells and pebbles, in methodical little rows, and out of this process, in some manner unknown to the popular mind, certain conjuring tricks—the celebrated wonders of science—in a sort of accidental way emerge. The popular conception of all discovery is accident. But you well know that the essential thing in the scientific process is not a marketable conjuring trick, but prophecy.

“And if I am right in saying that science aims at prophecy, and if the specialist in each science is in fact doing his best now to prophesy within the limits of his field, what is there to stand in the way of our building up this growing body of forecast into an ordered picture of the future that will be just as certain, just as strictly science, and perhaps just as detailed as the picture that has been built up within the last hundred years to make the geological past?

“In reply to which I would advance the suggestion that an increase in the number of human beings considered may positively simplify the case instead of complicating it; that as the individuals increase in number they begin to average out.

“Let me illustrate this point by a comparison. Angular pit sand has grains of the most varied shapes. Examined microscopically, you will find all sorts of angles and outlines and variations. Before you look you can say of no particular grain what its outline will be. And if you shoot a load of such sand from a cart you cannot foretell with any certainty where any particular grain will be in the heap that you make; but you can tell—you can tell pretty definitely—the form of the heap as a whole. And further, if you pass that sand through a series of chutes and finally drop it some distance to the ground, you will be able to foretell that grains of a certain sort of form and size will for the most part be found in one part of the heap. In such a case, you see, the thing as a whole may be simpler than its component parts, and this I submit is also the case in many human affairs. So that because the individual future eludes us completely, that is no reason why we should not aspire to, and discover and use, safe and serviceable generalizations upon countless important issues in the human destiny.

“Such, then, is the sort of knowledge of the future that I believe is attainable and worth attaining. I believe that the deliberate and courageous reference to the future, in moral and religious discussion, would be enormously stimulating and enormously profitable to our intellectual life.

“It is possible to believe that all past is but the beginning of a beginning, and that all that is and has been is but the twilight of the dawn. It is possible to believe that all that the human mind has ever accomplished is but the dream before the awakening. We cannot see, there is no need for us to see, what this world will be like when the day has fully come. We are creatures of the twilight. But it is out of our race and lineage that minds will spring, that will reach back to us in our littleness to know us better than we know ourselves, and that will reach forward fearlessly to comprehend this future that defeats our eyes. All this world is heavy with the promise of greater things, and a day will come, one day in the unending succession of days, when beings who are now latent in our thoughts and hidden in our loins, shall laugh and REACH OUT THEIR HANDS AMIDST THE STARS.”

In closing, I believe H. G. Wells is describing some of the principles of our new theory of Social Quantum Mechanics.

I am also struck by the similarity between administrative theory and theology. Theology is the application of one's religious beliefs in the world; it is where “the rubber meets the road.” Similarly, administrative theory is the application of one's social, organization, philosophical, and administrative beliefs in the world. Perhaps administrative theory, as a pathway to civilization building, is just a secular version of theology and another continuing chapter in “His story” together with other religions in the world! (Ref. The Leadership of Civilization Building, page 232.)

Additional information in regard to these subjects can be found in the book, The Leadership of Civilization Building, (Administrative and Civilization Theory, Symbolic Dialogue, and Citizen Skills for the 21st Century), copyright 2002 by Richard J. Spady and Richard S. Kirby and published by the Forum Foundation. The ISBN number is 0-9700534-9-5.

1. A Polarization-Consensus Rating (PC Rating™) in which it is recognized that every mathematician in the world speaks the same language, and every schoolboy in the world uses the same numbers including percentages so math is a universal language, and I have invented a new social indicator and algorithm composed of two percentages in juxtaposition to each other that is unrivaled in its ability to convey meaning quickly and accurately without information overload because summary reports never get bigger they just get better as more people participate for the process uses statistical universes with a disclaimer clause and not random samples and different rules apply as the first indicator (on a yes/no question) is composed of the Polarization Rating which is a percentage and first order derivative of the number of persons participating who were polarized and answered yes or no excluding those who abstained or objected, and it is a measure of the weight given a question by those participating while the second indicator (on a yes/no question) is composed of the Consensus Rating that is a percentage and second order derivative of the number of persons participating being the percent positive of those who were polarized and answered yes or no excluding those who abstained or objected so it is a measure of the opinion of those persons participating who were polarized thus this enables the elimination of showing the % yes and % no on any row, and since our Fast Forum program can reorder all questions by the Polarization Rating people only need to look at one number the Consensus Rating, to deduce the meaning instead of two and that one number accurately reflects the opinion of every individual proportionately regardless of the number participating.

2. A Converted Polarization-Consensus Rating (CPC Rating™) in which it is recognized that every mathematician in the world speaks the same language, and every schoolboy in the world uses the same numbers including percentages so math is a universal language, and I have invented a new social indicator and algorithm composed of two percentages in juxtaposition to each other that is unrivaled in its ability to convey meaning quickly and accurately without information overload because summary reports never get bigger they just get better as more people participate for the process uses statistical universes with a disclaimer clause and not random samples and different rules apply as the first indicator on a Likert value scale question (i.e., strongly agree, agree, neutral, disagree, strongly disagree) is composed of the Polarization Rating which is a percentage and first order derivative of the number of persons participating who were polarized and answered strongly agree, agree, disagree or strongly disagree adding neutral responses to abstain and then excluding all who abstained or objected, and it is a measure of the weight given a question by those participating while the second indicator (on a Likert value scale question) is composed of the Consensus Rating which is a percentage and second order derivative of the number of persons participating being the percent positive of those who were polarized and answered strongly agree, agree, disagree, and strongly disagree excluding those who were neutral, abstained, or objected so it is a converted measure of the opinion of those persons participating who were polarized thus this enables the elimination of showing the % strongly agree, % agree, % neutral, % disagree, and % strongly disagree on any row, and since our Fast Forum program can reorder all questions by the Polarization Rating, people only need to look at one number, the consensus Rating, to deduce the meaning instead of 5 figures (i.e., strongly agree, agree, neutral, disagree, and strongly disagree) and that one number accurately reflects the opinion of every individual proportionately regardless of the number participating so this is a quantum jump in social indicator efficiency especially when you are analyzing data by decades for ages teenage through 80 plus total, (i.e., 9 rows and thus one can eliminate a 5×9 matrix of percentages) and still convey the essential meaning mathematically and accurately in the one Consensus Rating ordinal number.
